(19) United States
(12) Patent Application Publication
(10) Pub. No.: US 2023/0126114 A1
(43) Pub. Date: Apr. 27, 2023

(54) AUTHENTICATION CONTROL DEVICE, INFORMATION PROCESSING DEVICE, AUTHENTICATION SYSTEM, AUTHENTICATION CONTROL METHOD AND NON-TRANSITORY COMPUTER READABLE MEDIUM

(71) Applicant: NEC Corporation, Minato-ku, Tokyo (JP)

(72) Inventor: Tatsuki AKUTSU, Tokyo (JP)

(73) Assignee: NEC Corporation, Minato-ku, Tokyo (JP)

(21) Appl. No.: 17/908,150

(22) PCT Filed: Mar. 25, 2020
(86) PCT No.: PCT/JP2020/013382

§ 371 Date: Aug. 30, 2022

(51) Int. Cl. G06F 21/32; G06V 40/16; G06F 3/04883; G07C 9/37

(52) U.S. Cl. CPC G06F 21/32; G06V 40/172; G06F 3/04883; G07C 9/37

(57) ABSTRACT

An authentication control device according to the present disclosure is provided with: a camera control means which starts a camera in response to a user's input operation to an input means of an information processing device equipped with an input means to photograph an image including the user's face; an image acquisition means which acquires the image photographed by the camera; and an authentication control means which causes an authentication device which performs face authentication to perform face authentication of the user included in the image acquired by the image acquisition means.

### TECHNICAL FIELD

The present disclosure relates to authentication control device, information processing device, authentication system, authentication control method and non-transitory computer readable medium.

### BACKGROUND ART

Patent Document 1 describes the following system. The system first performs face authentication based on face information extracted from a camera image of the face of the authentication object person and authentication (verification) based on identification information input by the authentication object person. The system performs the usual payment processing if face authentication is successful. Even if face authentication fails, the system will still perform normal payment processing if authentication (matching) by identifying information is successful.

### CITATION LIST

### Patent Literature

Patent Literature 1: Japanese Unexamined Patent Application Publication No. 2019-36888

### SUMMARY OF INVENTION

### Technical Problem

However, in the Patent Literature 1, no proposal has been made as to a desirable camera starting (activating) timing for photographing the face of the authentication object person.

In view of the aforementioned issues, the purpose of this disclosure is to provide authentication control device, information processing device, authentication system, authentication control method and non-transitory computer readable medium that can start (activate) a camera at an appropriate time to photograph the face of an authentication object person.

### Solution to Problem

An authentication control device according to a first aspect of the present disclosure includes: an image acquisition means for acquiring an image including a camera control means for photographing an image including the face of the user by starting a camera in response to the user's input operation to the input means of an information processing device equipped with an input means; an image acquisition means for acquiring the image photographed by the camera; authentication control means for causing an authentication device for performing face authentication to perform face authentication of the user included in the image acquired by the image acquisition means.

An information processing device according to a second aspect of the present disclosure includes: an input means; a camera control means for photographing an image including the face of the user by starting a camera in response to the user's input operation to the input means; an image acquisition means for acquiring the image photographed by the camera; a communication means for transmitting the image acquired by the image acquisition means.

An authentication system according to a third aspect of the present disclosure includes: an input means; a camera control means for photographing an image including the face of the user by starting a camera in response to the user's input operation to the input means; an image acquisition means for acquiring the image photographed by the camera; a face authentication means for executing face authentication of the user included in the image acquired by the image acquisition means.

An authentication control method according to a fourth aspect of the present disclosure includes: a camera control step of photographing an image including the face of the user by starting a camera in response to the user's input operation to the input means of an information processing device equipped with an input means; an image acquisition step of acquiring the image photographed by the camera; authentication control step of causing an authentication device for performing face authentication to perform face authentication of the user included in the image acquired by the image acquisition means.

A non-transitory computer readable medium according to a fifth aspect of the present disclosure is a non-transitory computer readable medium storing a program for causing an electronic device having at least one processor to execute: a camera control processing of photographing an image including the face of the user by starting a camera in response to the user's input operation to the input means of an information processing device equipped with an input means; an image acquisition processing of acquiring the image photographed by the camera; authentication control processing of causing an authentication device for performing face authentication to perform face authentication of the user included in the image acquired by the image acquisition means.

### Advantageous Effects of Invention

According to the present disclosure, it is possible to provide authentication control device, information processing device, authentication system, authentication control method and non-transitory computer readable medium that can start (activate) a camera at an appropriate time to photograph the face of an authentication object person.

### BRIEF DESCRIPTION OF DRAWINGS

FIG. 1 is a schematic configuration diagram of the authentication control device 20;

FIG. 2 is a flowchart showing an example of the operation of the authentication control device 20;

FIG. 3 is a block diagram showing the configuration of the authentication system according to the second embodiment;

FIG. 4 is a schematic configuration diagram of the authentication device 10;

FIG. 5 is a flowchart showing an example of the operation (face information registration processing) of the authentication device 10;

FIG. 6 is a flowchart showing an example of the operation (face authentication processing) of the authentication device 10;

FIG. 7 is a schematic configuration diagram of the authentication control device 20;

FIG. 8 is an external view of the settlement terminal 30;

FIG. 9 is a schematic configuration diagram of the settlement terminal 30;

FIG. 10 is a sequence diagram of the authentication system 1 (first operation example);

FIG. 11 shows an example of the settlement execution inquiry screen G2; and

FIG. 12 is a sequence diagram of the authentication system 1 (second operation example).

### EXAMPLE EMBODIMENT

### Embodiment 1

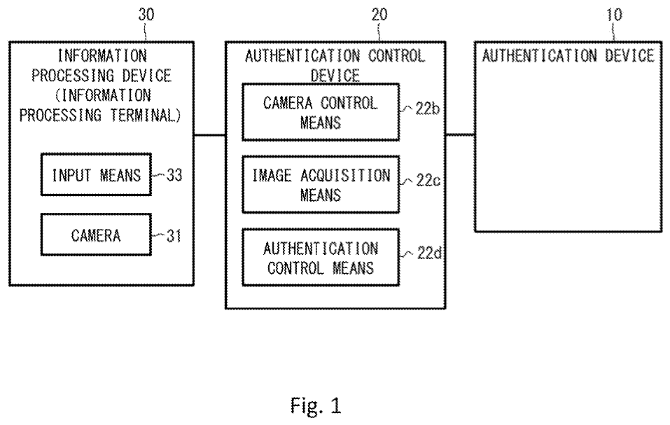

First, with reference to FIG. 1, an example of the configuration of an authentication control device 20 constituting an authentication system 1 of the first embodiment will be described.

FIG. 1 is a schematic configuration diagram of the authentication control device 20.

As shown in FIG. 1, an authentication control device 20 is provided with a camera control means 22b for starting a camera 31 in response to an input operation of a user (authentication object person) to an input means 33 of an information processing device 30 provided with the input means 33 to photograph an image including the user's face, an image acquisition means 22c for acquiring the image photographed by the camera 31, and an authentication control means 22d for causing an authentication device 10 which executes face authentication to execute face authentication of the user included in the image acquired by the image acquisition means 22c.

Next, an example of the operation of the authentication control device 20 having the above configuration will be described.

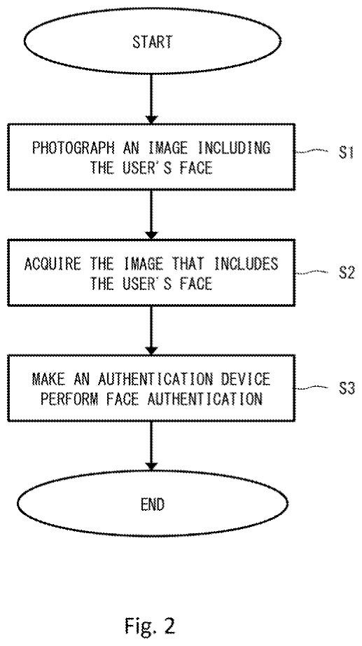

FIG. 2 is a flowchart showing an example of the operation of the authentication control device 20.

First, the camera control means 22b starts the camera 31 according to the input operation of the user to the input means 33 of the information processing device 30 provided with the input means 33 to photograph an image including the user's face (Step S1).

Next, the image acquiring unit 22c acquires the image photographed by the camera 31 (Step S2).

Next, the authentication control means 22d causes the authentication device 10 for executing face authentication to perform face authentication of the user included in the image acquired by the image acquisition means 22c.

As described above, according to Embodiment 1, the camera 31 can be started at an appropriate timing in accordance with the user's input operation to the input means 33 to photograph the user's face. As a result, power consumption can be reduced as compared with the case where the camera 31 is always activated.

### Embodiment 2

The authentication system 1 will now be described in detail as Embodiment 2 of the present disclosure. Hereinafter, a camera control unit is used as the camera control means 22b. Hereinafter, the camera control unit will be referred to as the camera control unit 22b. An image acquisition unit is used as the image acquisition means 22c. Hereinafter, the image acquisition unit will be referred to as the image acquisition unit 22c. An authentication control unit is used as the authentication control means 22d. Hereinafter, the authentication control unit will be referred to as the authentication control unit 22d. A settlement terminal is used as the information processing device 30. Hereafter, it is described as a settlement terminal 30. A touch panel is used as the input means 33. Hereafter, it is described as a touch panel 33.

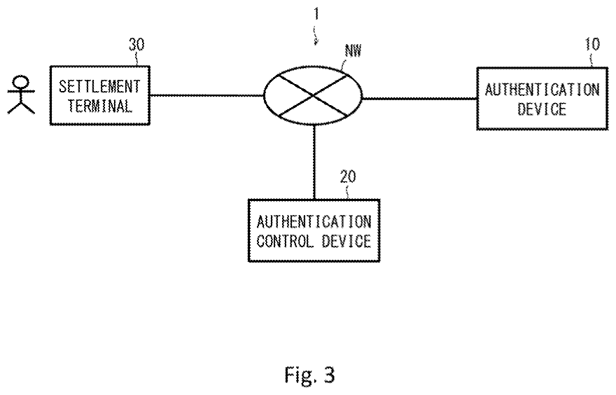

FIG. 3 is a block diagram showing the configuration of the authentication system according to the second embodiment.

The authentication system 1 includes the authentication device 10, the authentication control device 20, and a settlement terminal 30 which can communicate with each other via a network NW (For example, the Internet).

First, a configuration example of the authentication device 10 will be described.

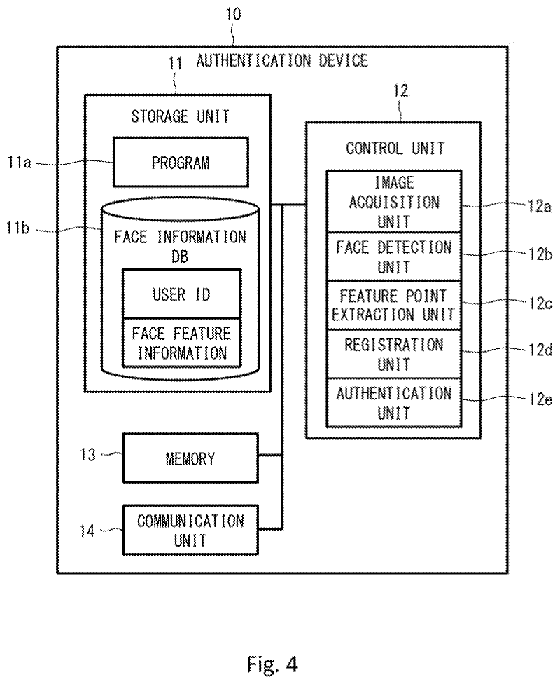

FIG. 4 is a schematic configuration diagram of the authentication device 10.

As shown in FIG. 4, the authentication device 10 includes a storage unit 11, a control unit 12, a memory 13, and a communication unit 14.

The storage unit 11 is, for example, a nonvolatile storage unit such as a hard disk drive or ROM. The storage unit 11 stores a program 11a and a face information DB 11b.

The program lla is a program executed by the control unit 12 (processor). In the face information DB 11b, user ID (plural) and face feature information of the user are stored (registered) in association with each other. In response to a face authentication request received from the outside (For example, the authentication control device 20), the authentication device 10 verifies a face image or a face feature information included in the request against the face feature information of each user, and returns the result of the verification to the request source.

The control unit 12 includes a processor (not shown). The processor is, for example, a central processing unit (CPU). There may be one or more processors. The processor executes the program lla read from the storage unit 11 into the memory 13 (For example, RAM) to function as an image acquisition unit 12a, a face detection unit 12b, a feature point extraction unit 12c, a registration unit 12d, and an authentication unit 12e. Some or all of these may be implemented in hardware.

The image acquisition unit 12a acquires an image including the face of an user. For example, the image acquisition unit 12a acquires an image received by the communication unit 14. The image received by the communication unit 14 is an image for registration transmitted from a user terminal (not shown) or an image for authentication (verification) transmitted from the authentication control device 20.

The face detection unit 12b detects a face area from the image acquired by the image acquisition unit 12a and outputs the detected face area to the feature point extraction unit 12c.

The feature point extraction unit 12c extracts a feature point (For example, facial features such as eyes, nose, mouth corners, etc.) from the face area detected by the face detection unit 12b.

When the image acquired by the image acquisition unit 12a is an image for registration, the feature point extraction unit 12c outputs the face feature information to the registration unit 12d. The face feature information is a set of extracted feature points. On the other hand, when the image acquired by the image acquisition unit 12a is an image for authentication, the feature point extraction unit 12c outputs the face feature information to the authentication unit 12e.

The registration unit 12d newly issues a user ID when registering face feature information. The registration unit 12d associates the issued user ID with face feature information extracted from the image for registration and registers them in the face information DB 11b.

The authentication unit 12e verifies the face feature information extracted from the face area detected from the image for authentication against the face feature information in the face information DB 11b. The authentication unit 12e returns the presence or absence of coincidence of the face feature information to the authentication control device 20. The presence or absence of the coincidence of the face feature information corresponds to the success or failure of the authentication.

The communication unit 14 is a communication device that communicates with the authentication control device 20 via the network NW.

Next, an example of the operation (face information registration processing) of the authentication device 10 will be described.

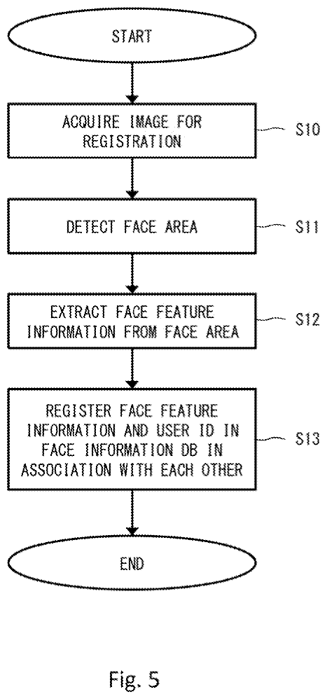

FIG. 5 is a flowchart showing an example of the operation (face information registration processing) of the authentication device 10.

First, the authentication device 10 (the image acquisition unit 12a) acquires an image (image for registration) including the face of the user included in a face information registration request (Step S10). For example, the authentication device 10 (the communication unit 14) receives the face information registration request from a user terminal (not shown) via the network NW.

Next, the authentication device 10 (the face detection unit 12b) detects a face area from the image for registration acquired in Step S10 (Step S11). Next, the authentication device 10 (the feature point extraction unit 12c) extracts feature points of the face from the face area detected in Step S11 (Step S12), and outputs the face feature information to the registration unit 12d. Finally, the authentication device 10 (the registration unit 12d) issues a user ID and registers the user ID and the face feature information in association with each other in the face information DB 11b (Step S13). Note that the authentication device 10 may receive the face feature information from the face authentication terminal or the like and register it in the face information DB 11b in association with the user ID.

Next, an example of the operation (face authentication processing) of the authentication device 10 will be described.

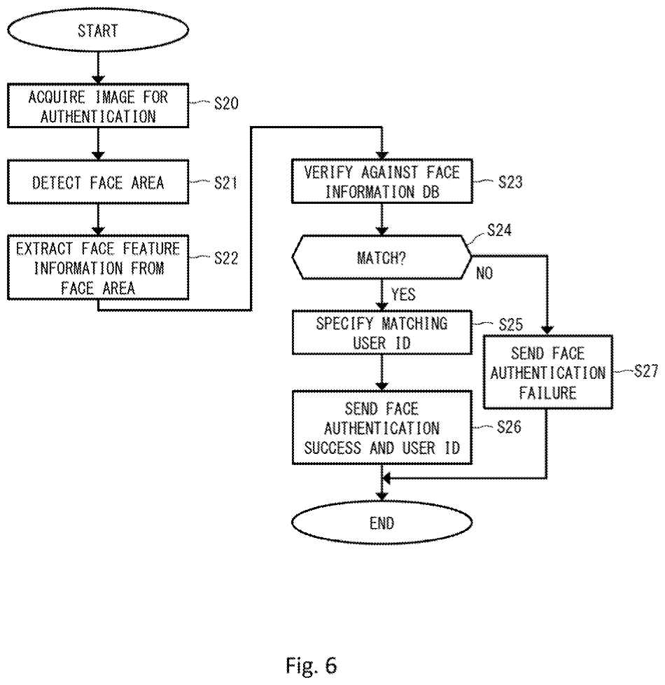

FIG. 6 is a flowchart showing an example of the operation (face authentication processing) of the authentication device 10.

First, the authentication device 10 (the image acquisition unit 12a) acquires an image (image for authentication) including the face of the user included in a face authentication request (Step S20). For example, the authentication device 10 (the communication unit 14) receives the face authentication request from the authentication control device 20 via the network NW. Next, the authentication device 10 (the face detection unit 12b) detects a face area from the image for authentication acquired in Step S20 (Step S21). Next, the feature point extraction unit 12c extracts feature points of the face from the face area detected in Step S21 (Step S22). Alternatively, the authentication device 10 may receive the face feature information from the authentication control device 20. Next, the authentication device 10 (the authentication unit 12e) verifies the acquired face feature information against the face information DB 11b (Step S23). If the face feature information matches (Yes in Step S24), the authentication unit 12e specifies the user ID of the user whose face feature information matches (Step S25), and returns the fact that the face authentication is successful and the specified user ID to the authentication control device 20 (Step S26). If there is no matching face feature information (No in Step S24), the authentication unit 12e returns the fact that the face authentication has failed to the authentication control device 20 (Step S27).

Next, a configuration example of the authentication control device 20 will be described.

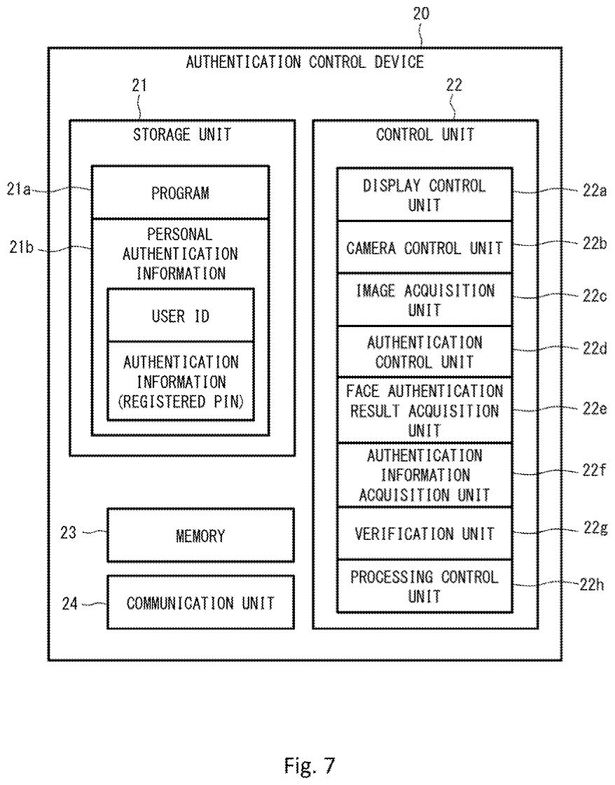

FIG. 7 is a schematic configuration diagram of the authentication control device 20.

The authentication control device 20 is an information processing device that executes authentication control processing, and is, for example, a server apparatus implemented by a computer.

As shown in FIG. 7, the authentication control device 20 includes a storage unit 21, a control unit 22, a memory 23, and a communication unit 24.

The storage unit 21 is a nonvolatile storage unit such as a hard disk drive or ROM. The storage unit 21 stores a program 21a and personal authentication information 21b.

The program 21a is a program executed by the control unit 22 (processor). The personal authentication information 21b is information in which the user ID (plural) are associated with the authentication information of the user. The authentication information is, for example, a PIN (Personal Identification Number). Hereinafter, the authentication information is referred to as a registered PIN. The PIN is also called, for example, PIN information or PIN code. PIN is a simple code consisting of a combination of a plurality of elements (For example, numbers, letters, and symbols.) and having a number of digits of about 10 digits or less. One user ID is assigned to one user. On the other hand, one PIN is assigned to a plurality of users. One PIN may be assigned to one user.

The control unit 22 includes a processor (not shown). The processor is, for example, a central processing unit (CPU). There may be one or more processors. The processor executes the program 21a read from the storage unit 21 into the memory 23 (For example, RAM) to function as a display control unit 22a, a camera control unit 22b, an image acquisition unit 22c, an authentication control unit 22d, a face authentication result acquisition unit 22e, an authentication information acquisition unit 22f, a verification unit 22g, and a processing control unit 22h. Some or all of these may be implemented in hardware.

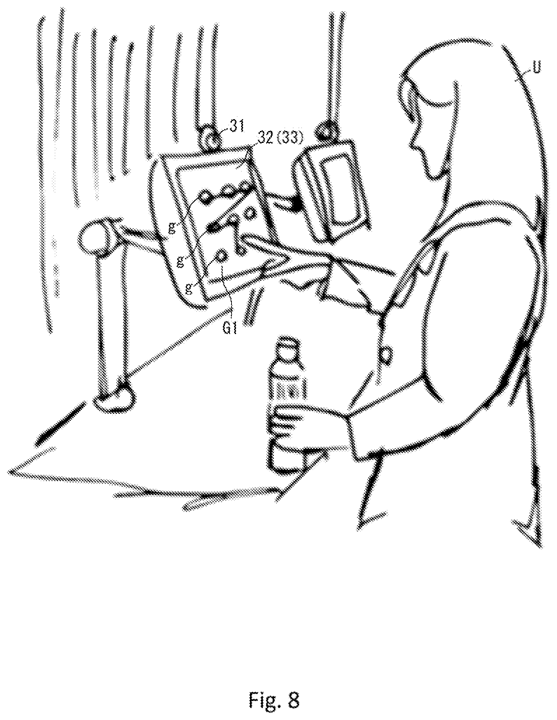

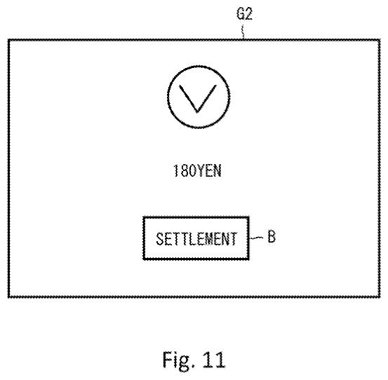

For example, the display control unit 22a causes the settlement terminal 30 to display a PIN input acceptance screen G1 (an authentication information input screen. See FIG. 8) on a display surface of a display unit 32 of the settlement terminal 30. Specifically, the display control unit 22a transmits a screen display instruction for causing the settlement terminal 30 to display the PIN input acceptance screen G1 to the settlement terminal 30 via the communication unit 24. In the case of causing the settlement terminal 30 to display another screen, for example, a settlement execution inquiry screen G2 (see FIG. 11), a similar screen display instruction is transmitted to the settlement terminal 30 via the communication unit 24. The PIN input acceptance screen G1 and the settlement execution inquiry screen G2 will be described later.

The camera control unit 22b causes the camera 31 of the settlement terminal 30 to start (activate) according to an input operation of a user U to a touch panel 33 of the settlement terminal 30 to causes the camera 31 to photograph an image including the face of the user U. More specifically, when the communication unit 24 receives the input start detection notification (notification that the user U has started to input the PIN) transmitted from the settlement terminal 30, the camera control unit 22b transmits a photographing instruction to the settlement terminal 30 via the communication unit 24.

The image acquisition unit 22c acquires an image (hereinafter also referred to as a photographed image) photographed by the camera 31 started by the camera control unit 22b. Specifically, the communication unit 24 receives the photographed image transmitted from the settlement terminal 30, and the image acquisition unit 22c acquires the photographed image received by the communication unit 24.

The authentication control unit 22d causes the authentication device 10 for executing face authentication to perform face authentication of the user U included in the photographed image acquired by the image acquisition unit 22c. Specifically, the authentication control unit 22d transmits the photographed image acquired by the image acquisition unit 22c to the authentication device 10 via the communication unit 24. In place of the photographed image, a face area detected from the photographed image (or a feature point extracted from the face area) may be transmitted to the authentication device 10.

The face authentication result acquisition unit 22e acquires the result of the face authentication executed by the authentication device 10. Specifically, the communication unit 24 receives the result of the face authentication transmitted from the authentication device 10, and the face authentication result acquisition unit 22e acquires the result of the face authentication received by the communication unit 24.

The authentication information acquisition unit 22f acquires the PIN (hereinafter referred to as an input PIN) inputted through the touch panel 33 of the settlement terminal 30. Specifically, the communication unit 24 receives the input PIN transmitted from the settlement terminal 30, and the authentication information acquisition unit 22f acquires the input PIN received by the communication unit 24.

The verification unit 22g verifies the input PIN acquired by the authentication information acquisition unit 22f against the registered PIN (see FIG. 7) stored in the storage unit 21.

The processing control unit 22h causes the settlement terminal 30 that executes settlement processing to execute settlement processing, when the face authentication by the authentication device 10 is successful and the verification result by the verification unit 22g matches. Specifically, the settlement processing control unit 22h transmits a settlement processing instruction to the settlement terminal 30 via the communication unit 24. The settlement processing is an example of the predetermined processing of the present invention.

Next, a configuration example of the settlement terminal 30 will be described.

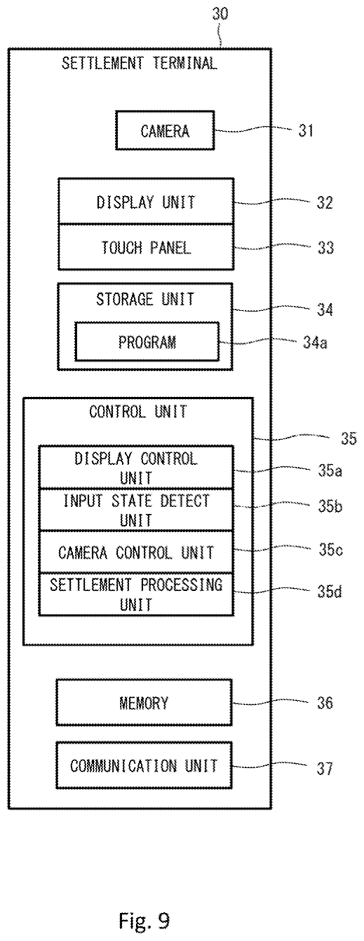

FIG. 8 is an external view of the settlement terminal 30, and FIG. 9 is a schematic configuration diagram of the settlement terminal 30.

As shown in FIGS. 8 and 9, the settlement terminal 30 is an information processing device including a camera 31, a display unit 32, a touch panel 33, a storage unit 34, a control unit 35, a memory 36, and a communication unit 37. The settlement terminal 30 is installed in a store, for example. The authentication device 10 and the authentication control device 20 may be installed in the same store or in a remote location from the store.

The settlement terminal 30 executes face authentication and PIN verification (two-factor authentication) before settlement processing. When the face authentication is successful and the result of the PIN verification matches, the settlement terminal 30 executes settlement processing. The processing before and after the two-factor authentication, such as the input (reading) of the purchased goods and the settlement processing itself, can be executed by using known techniques, and therefore a detailed description thereof will be omitted.

The camera 31 photographs an image including the face of the user U. For example, as shown in FIG. 8, the camera 31 photographs the face of the user U inputting the PIN via the touch panel 33, that is, the face of the user U facing the display surface (and the camera 31 placed in the vicinity) of the display unit 32 where the PIN input acceptance screen G1 is displayed, from the front or approximately the front. To enable this, the camera 31 is mounted on the upper part of the frame of the display unit 32, for example.

The display unit 32 is, for example, a display such as a display with a touch panel. The display with the touch panel is also called a touch screen display. On the display surface of the display unit 32, for example, the PIN input acceptance screen G1 is displayed. As shown in FIG. 8, the PIN input acceptance screen G1 includes an image g representing each element constituting a PIN to be traced by the finger of the user U via the touch panel 33. Each image g is displayed on the display surface of the display unit 32 in a state of being arranged in a predetermined pattern. For example, the image g is displayed in a state of being arranged in a 3 x 3 lattice pattern (see FIG. 8).

The touch panel 33 is an input device operated by the user U. The touch panel 33 is arranged so as to cover the display surface of the display unit 32. The touch panel 33 is used, for example, for inputting a PIN by the finger of the user U. The user U moves his/her finger in contact with the touch panel 33 on the touch panel 33, and inputs the PIN by tracing (passing through) an image g corresponding to an element constituting the PIN sequentially from the beginning of the PIN. In this case, since the PIN is a simple code of about 10 digits or less, which is composed of a combination of a plurality of elements (For example, numbers, letters, and symbols.), and the PIN can be input only by moving a finger several times so as to follow the image g, the burden of the PIN input of the user U is reduced.

The PIN may be input by tapping a software keyboard (not shown) displayed on the display surface of the display unit 32 through the touch panel 33, or may be input through a physical keyboard (not shown) arranged near the display unit 32.

The storage unit 34 is a nonvolatile storage unit such as a hard disk drive or ROM. The storage unit 34 stores a program 34a.

The program 34a is a program executed by the control unit 35 (processor).

The control unit 35 includes a processor (not shown). The processor is, for example, a central processing unit (CPU). There may be one or more processors. The processor executes the program 34a read from the storage unit 34 into the memory 36 (For example, RAM) to function as a display control unit 35a, an input state detection unit 35b, a camera control unit 35c, and a settlement processing unit 35d. Some or all of these may be implemented in hardware.

For example, when the communication unit 37 receives the screen display instruction (the screen display instruction for displaying the PIN input acceptance screen G1) sent from the authentication control device 20, the display control unit 35a displays the PIN input acceptance screen G1 (see FIG. 8) on the display surface of the display unit 32. The PIN input acceptance screen G1 may be displayed based on information previously stored in the storage unit 34 of the settlement terminal 30, or may be displayed based on information received from the authentication control device 20 together with the screen display instruction.

The input state detection unit 35b detects the input state of the PIN. The input state of the PIN detected by the input state detection unit 35b is, for example, the start of PIN input and the end of PIN input.

For example, when the communication unit 37 receives a photographing instruction transmitted from the authentication control device 20, the camera control unit 35c starts the camera 31 to photograph an image including the face of the user U. For example, the camera 31 is started by supplying power to the camera 31 or shifting the camera 31 from the sleep state to the normal state. On the other hand, when the photographing is completed, the camera control unit 35c stops the start of the camera 31. For example, the start of the camera 31 is stopped by stopping the power supply to the camera 31 or shifting the camera 31 to the sleep state.

The settlement processing unit 35d executes settlement processing when the communication unit 37 receives, for example, a settlement processing instruction transmitted from the authentication control device 20. That is, the payment processing is completed on the basis of the settlement information associated with the face-authenticated user U.

The communication unit 37 is a communication device that communicates with the authentication control device 20 via the network NW.

Next, an operation example (first operation example) of the authentication system 1 having the above configuration will be described.

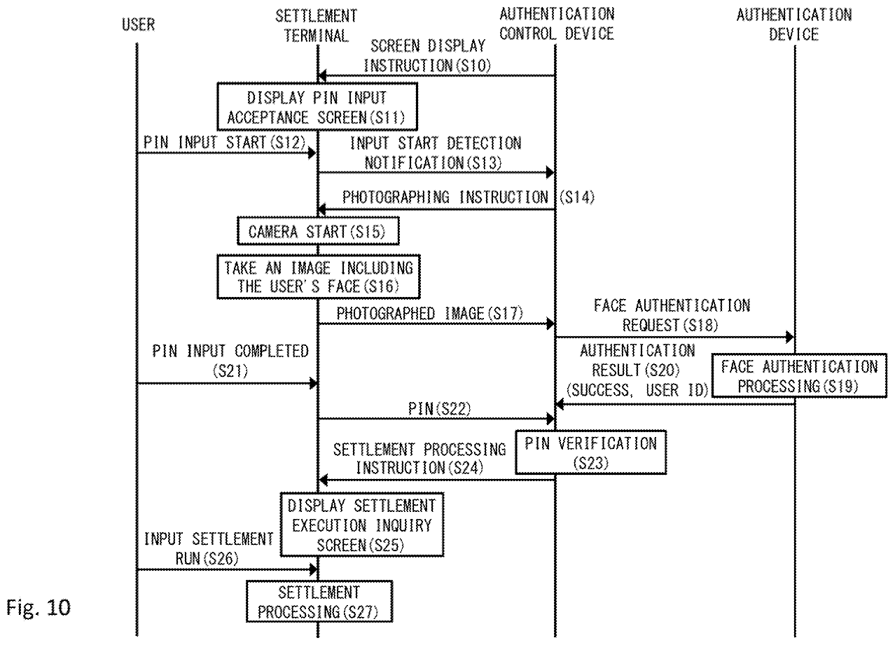

FIG. 10 is a sequence diagram of the authentication system 1 (first operation example).

As shown in FIG. 10, first, the authentication control device 20 (the display control unit 22a) transmits a screen display instruction for displaying the PIN input acceptance screen G1 to the settlement terminal 30 via the communication unit 24 (Step S10).

Next, when the communication unit 37 receives the screen display instruction transmitted in Step S10, the settlement terminal 30 (the display control unit 35a) displays the PIN input acceptance screen G1 (see FIG. 8) on the display surface of the display unit 32 (Step S11).

Next, the settlement terminal 30 starts the camera 31 according to the input operation of the user U to the touch panel 33, and photographs an image including the face of the user U (steps S12 to S16).

Specifically, the user U starts to input the PIN assigned to the user U via the touch panel 33 (Step S12). For example, the user U moves his/her finger in contact with the touch panel 33 on the touch panel 33, and inputs the PIN by tracing (passing through) the image g corresponding to the elements constituting the PIN in order from the beginning of the PIN. The settlement terminal 30 (the input state detection unit 35b) detects the start of PIN input.

Next, when the input state detection unit 35b detects the start of PIN input, the settlement terminal 30 (the communication unit 37) transmits an input start detection notification to the authentication control device 20 (Step S13).

Next, when the communication unit 24 receives the input start detection notification transmitted in Step S13, the authentication control device 20 (the camera control unit 22b) transmits a photographing instruction to the settlement terminal 30 via the communication unit 24 (Step S14).

Next, when the communication unit 37 receives the photographing instruction transmitted in Step S14, the settlement terminal 30 (the camera control unit 35c) starts the camera 31 (Step S15) to photograph an image including the face of the user U who has input the PIN via the touch panel 33 (Step S16). The number of shots may be one or a plurality of shots. When the photographing is finished, the camera control unit 35c stops the start of the camera 31.

As described above, the settlement terminal 30 starts the camera 31 in response to the input operation of the user U to the touch panel 33 to take an image including the face of the user U.

Next, the settlement terminal 30 (communication unit 37) transmits the photographed image taken in Step S16 to the authentication control device 20 (Step S17). In this case, the camera control unit 35c may end photographing of the camera 31 (or may stop starting the camera 31) at the timing when the photographed image is transmitted.

Next, the authentication control device 20 (communication unit 24) receives the photographed image transmitted in Step S17, and the image acquisition unit 22c acquires the photographed image received by the communication unit 24.

Next, the authentication control device 20 (the authentication control unit 22d) transmits a face authentication request requesting face authentication of the user U included in the acquired photographed image to the authentication device 10 via the communication unit 24 (Step S18). The face authentication request includes the acquired photographed image.

Next, when the communication unit 14 receives the face authentication request transmitted in Step S18, the authentication device 10 executes a face authentication processing (see FIG. 6) (Step S19).

Next, the authentication device 10 (the authentication unit 12e) transmits the authentication result to the authentication control device 20 of the face authentication request transmission source via the communication unit 14 (Step S20). It is assumed here that, as the result of the authentication, the fact that the authentication was successful and the user ID of the authenticated user U are transmitted to the authentication control device 20.

Next, the authentication control device 20 (the communication unit 24) receives the face authentication result and the user ID transmitted in Step S20, and the face authentication result acquisition unit 22e acquires the face authentication result received by the communication unit 24.

The settlement terminal 30 (communication unit 37) transmits the input PIN to the authentication control device 20 when the input state detection unit 35b detects the end of the PIN input (Step S22). The authentication control device 20 (communication unit 24) receives the input PIN transmitted in Step S22, and the authentication information acquisition unit 22f acquires the input PIN received by the communication unit 24.

Next, the authentication control device 20 (the verification unit 22g) performs PIN verification (Step S23). This PIN verification is a process of verifying an input PIN acquired by the authentication information acquisition unit 22f against a registered PIN (a registered PIN to which the acquired user ID is associated) stored in the storage unit 21.

Next, when the face authentication is successful (The result of the face authentication acquired by the face authentication result acquisition unit 22e indicates that the authentication is successful.) and the result of the PIN verification in Step S23 matches, the authentication control device 20 (the communication unit 24) transmits a settlement processing instruction to the settlement terminal 30 via the communication unit 24 (Step S24).

Next, when the communication unit 37 receives the settlement processing instruction transmitted in Step S24, the settlement terminal 30 (the display control unit 35a) displays a settlement execution inquiry screen (see FIG. 11) on the display surface of the display unit 32, indicating whether or not to execute settlement (Step S25). FIG. 11 shows an example of the settlement execution inquiry screen G2.

Next, when the user U inputs the settlement execution, for example, when the user U taps the settlement button B in the settlement execution inquiry screen through the touch panel 33, the settlement terminal 30 (the settlement processing unit 35d) executes the settlement processing (Step S27). In this case, the camera control unit 35c may end photographing of the camera 31 (or may stop starting the camera 31) at the timing when the user U taps the settlement button B via the touch panel 33.

If the face authentication fails (When the result of the face authentication acquired by the face authentication result acquisition unit 22e indicates that the authentication has failed.) or if the result of the PIN verification in Step S23 does not match, the processes in steps S24 to S27 are not executed. In this case, for example, a failure of authentication is displayed on the display unit 32. As described above, according to the operation example (first operation example) of the authentication system 1, the face authentication (Step S19) is performed before the PIN verification (Step S23), so that the face authentication can be performed quickly (Quick response possible).

Next, an operation example (second operation example) of the authentication system 1 having the above configuration will be described.

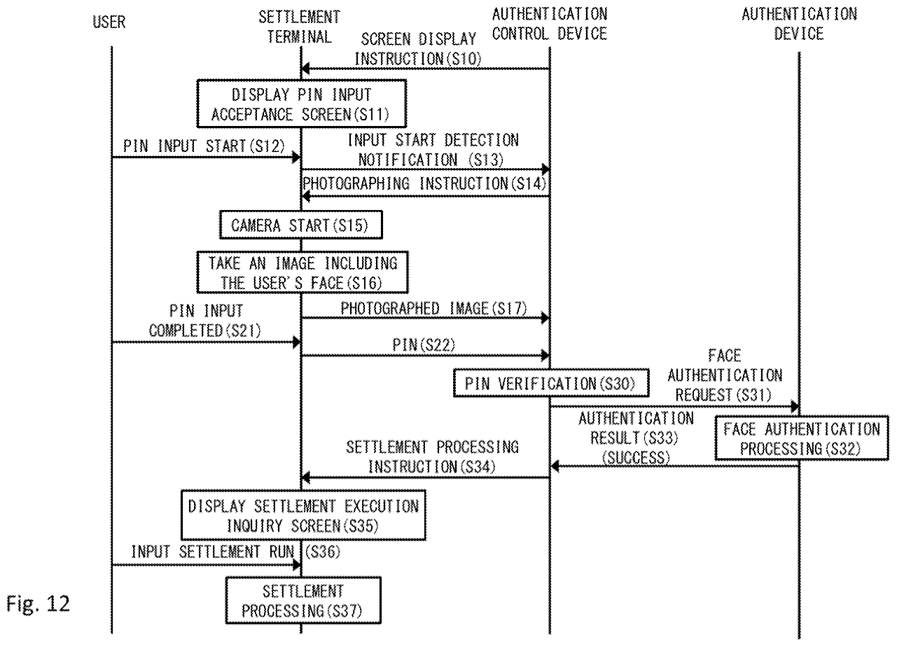

FIG. 12 is a sequence diagram of the authentication system 1 (second operation example).

In the first operation example, the face authentication processing is executed using the face feature information of all the user IDs registered in the face information DB 11b, while in the second operation example, the face authentication processing is executed using the face feature information of the user ID to which the input PIN is associated among the user IDs registered in the face information DB 11b. Since the processes of steps S10 to S22 are the same as those of the first operation example, the same reference numerals are used and the description thereof is omitted. Hereinafter, steps S30 to S37 following Step S22 will be mainly described.

First, as a premise, the authentication control device 20 (the communication unit 24) receives the photographed image transmitted in Step S17, and the image acquisition unit 22c acquires the photographed image received by the communication unit 24. The authentication control device 20 (communication unit 24) receives the input PIN transmitted in Step S22, and the authentication information acquisition unit 22f acquires the input PIN received by the communication unit 24.

Next, the authentication control device 20 (the verification unit 22g) performs PIN verification (Step S30). This PIN verification is a process of verifying the input PIN acquired by the authentication information acquisition unit 22f with the registered PIN (all PINs) stored in the storage unit 21, and extracting from the storage unit 21 a user ID to which the input PIN acquired by the authentication information acquisition unit 22f is associated.

Next, when the user ID is extracted as a result of the PIN verification in Step S30, the authentication control device 20 (the authentication control unit 22d) transmits a face authentication request requesting face authentication of the user U included in the acquired photographed image to the authentication device 10 via the communication unit 24 (Step S31). The face authentication request includes the acquired photographed image and the user ID extracted in Step S30.

Next, when the communication unit 14 receives the face authentication request transmitted in Step S31, the authentication device 10 executes a face authentication processing (see FIG. 6) (Step S32). At this time, the authentication device 10 executes the face authentication processing using the face feature information of the user ID (For example, for 100 people.) extracted in Step S30, instead of the face feature information of all the user IDs (For example, for 1000 people.).

Next, the authentication device 10 (the authentication unit 12e) transmits the authentication result to the authentication control device 20 of the face authentication request transmission source (Step S33). Here, it is assumed that the authentication success is transmitted to the authentication control device 20 as the authentication result.

Next, the authentication control device 20 (communication unit 24) receives the result of the face authentication transmitted in Step S33, and the face authentication result acquisition unit 22e acquires the result of the face authentication received by the communication unit 24.

Next, if the result of the acquired face authentication indicates that the authentication is successful, the authentication control device 20 (communication unit 24) transmits a settlement processing instruction to the settlement terminal 30 (Step S34).

Next, upon receiving the settlement processing instruction transmitted in Step S34, the settlement terminal 30 (the display control unit 35a) displays on the display unit 32 a settlement execution inquiry screen (see FIG. 11) indicating whether to execute settlement (Step S35).

Next, when the user U inputs the settlement execution, for example, when the user U taps the settlement button B in the settlement execution inquiry screen (see FIG. 11) through the touch panel 33, the settlement terminal 30 executes the settlement processing (Step S37).

If the user ID is not extracted as a result of the PIN verification in Step S30, or if the face authentication fails (When the result of the face authentication acquired by the face authentication result acquisition unit 22e indicates that the authentication has failed.), the processes in steps S34 to S37 are not executed. In this case, for example, a failure of authentication is displayed on the display unit 32. As described above, according to the operation example (second operation example) of the authentication system 1, the face authentication (Step S32) can be performed after the PIN verification (Step S30) is narrowed down (For example, in the above example, after narrowing down the number from 1000 to 100,), so that the authentication accuracy can be improved.

As described above, according to Embodiment 2, the camera 31 can be started at an appropriate timing (For example, when the user U starts to input a PIN via the touch panel 33) in accordance with the user's input operation to the touch panel 33 to photograph the face of the user U. As a result, power consumption can be reduced as compared with the case where the camera 31 is always activated. In addition, if the camera 31 is always activated, there is an increased opportunity for a third party (For example, a third person passing across the field of view of the camera 31) other than the authentication object person to be photographed, which is undesirable from the viewpoint of privacy protection. On the other hand, in Embodiment 2, by starting the camera 31 at an appropriate timing according to the input operation of the user to the touch panel 33 (That is, when authentication is required,), it is possible to suppress the photographing of third parties other than the authentication object person.

Further, according to Embodiment 2, since the face of the user U is photographed at a timing (For example, when the user U starts to input a PIN via the touch panel 33) corresponding to the user's input operation to the touch panel 33, the face of the user U who is inputting the PIN via the touch panel 33, that is, the face of the user U facing (gazing at) the display surface of the display unit 32 (and the camera 31 arranged near the display surface) on which the PIN input acceptance screen G1 is displayed, can be photographed from the front or from the front. That is, the face of the user U can be photographed at an angle suitable for face authentication. Thus, the accuracy of face authentication can be expected to be improved.

Next, a modified example will be described.

Although Embodiment 2 has described an example in which the timing in response to the user's input operation to the touch panel 33 (the timing at which the camera 31 is activated to photograph the face of the user U) is the timing at which the user U starts to input a PIN via the touch panel 33, the present invention is not limited thereto. For example, the timing corresponding to the user's input operation to the touch panel 33 (the timing of starting the camera 31 and photographing the face of the user U) may be any timing after the start of PIN input and before the end of PIN input.

In this way, the face of the user U who is inputting the PIN via the touch panel 33, that is, the face of the user U facing (gazing at) the display surface of the display unit 32 (and the camera 31 disposed in the vicinity thereof) on which the PIN input acceptance screen G1 is displayed, can be photographed from the front or from the front. That is, the face of the user U can be photographed at an angle suitable for face authentication. Thus, the accuracy of face authentication can be expected to be improved.

Further, the timing corresponding to the user's input operation to the touch panel 33 (the timing of starting the camera 31 and photographing the face of the user U) may be the timing at which the user U has completed the input of the PIN or a timing after that.

In Embodiment 2, an example in which the camera 31 is mounted on the upper portion of the frame of the display unit 32 (see FIG. 8) has been described, but the present invention is not limited thereto. That is, the camera 31 may be mounted anywhere as long as it can be photographed at an angle suitable for face authentication. For example, it may be attached to the left or right portion of the frame of the display unit 32. Alternatively, it may be attached to a structure (For example, walls and columns) installed in the vicinity of the settlement terminal 30 or other places.

Although Embodiment 2 has described an example in which the predetermined process to be executed when the face authentication by the authentication device 10 is successful and the verification results by the verification unit 22g match each other is a settlement process, the present invention is not limited thereto. For example, the predetermined process may be a process of opening a gate or a door through which the user U passes, or another process.

Although Embodiment 2 has described an example in which the authentication system 1 is composed of the authentication device 10, the authentication control device 20, and the settlement terminal 30 which can communicate with each other via a network NW (For example, the Internet), the present invention is not limited thereto.

For example, all or part of the configuration or function of the authentication device 10 and the authentication control device 20 may be added to the settlement terminal 30. The configuration or function of the whole or a part of the settlement terminal 30 and the authentication device 10 may be added to the authentication control device 20.

In Embodiment 1, 2, the above program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

All the numeral values mentioned in the above-described example embodiments are merely examples, and needless to say, numeral values different from them can be uses as desired.

The above-described example embodiments are merely examples in all the aspects thereof. The present invention should not be limited by the descriptions of the above-described example embodiments. The present invention may be carried out in various other forms without departing from the spirit or main features of the invention.

The whole or part of the example embodiment disclosed above can be described as, but not limited to, the following supplementary notes.

### (Supplementary Note 1)

An authentication control device comprising:

a camera control means for photographing an image including the face of the user by starting a camera in response to the user's input operation to the input means of an information processing device equipped with an input means;

an image acquisition means for acquiring the image photographed by the camera;

authentication control means for causing an authentication device for performing face authentication to perform face authentication of the user included in the image acquired by the image acquisition means.

### (Supplementary Note 2)

The authentication control device according to Supplementary note 1, wherein

the input means is an input means that causes the user to input the authentication information assigned to the user,

the authentication control device further comprising:

an authentication information acquisition means for acquiring the authentication information entered via the input means;

a verification means for verifying the authentication information acquired by the authentication information acquisition means with the registered authentication information; and

when face authentication by the authentication device is successful and the verification result by the verification means matches, a processing control means for causing the processing means for executing the predetermined processing to execute the predetermined processing.

### (Supplementary Note 3)

3. The authentication control device according to Supplementary note 2, wherein the predetermined processing is a settlement processing and a processing for opening a gate or a door through which the user passes.

### (Supplementary Note 4)

The authentication control device according to Supplementary note 2 or 3, wherein

the camera control means starts the camera to photograph the image after the start of the input of the authentication information and before the end of the input.

### (Supplementary Note 5)

The authentication control device according to any one of Supplementary notes 2 to 4, further comprising:

input state detection means for detecting the input state of the authentication information; wherein

the camera control means controls the camera to photograph the image, when the start of input of the authentication information is detected by the input state detection means.

(Supplementary Note 6)

The authentication control device according to any one of Supplementary notes 1 to 5, wherein

camera control means stops starting of said camera when photographing is completed.

(Supplementary Note 7)

The authentication control device according to any one of Supplementary notes 1 to 6, wherein

the input means is an input means for inputting authentication information by a finger of the user.

(Supplementary Note 8)

The authentication control device according to Supplementary note 7, wherein

the input means is a touch panel arranged so as to cover the display surface of the display unit.

(Supplementary Note 9)

The authentication control device according to Supplementary note 8, further comprising:

a display control unit for displaying an authentication information input screen including images representing respective elements constituting the authentication information on a display surface of the display unit;

the images will be traced by the fingers of the user via the touch panel.

### (Supplementary Note 10)

The authentication control device according to any one of Supplementary notes 7 to 9, wherein

the camera is arranged to photograph the face of the user who is inputting

the authentication information via the input means from the front.

(Supplementary Note 11)

An information processing device comprising:

an input means;

a camera control means for photographing an image including the face of the user by starting a camera in response to the user's input operation to the input means;

an image acquisition means for acquiring the image photographed by the camera;

a communication means for transmitting the image acquired by the image acquisition means.

(Supplementary Note 12)

The information processing device according to Supplementary note 11, wherein

the camera control means starts the camera to photograph the image after the start of the input of the authentication information and before the end of the input.

(Supplementary Note 13)

An authentication system comprising:

an input means;

a camera control means for photographing an image including the face of the user by starting a camera in response to the user's input operation to the input means;

an image acquisition means for acquiring the image photographed by the camera;

a face authentication means for executing face authentication of the user included in the image acquired by the image acquisition means.

(Supplementary Note 14)

An authentication system according to Supplementary note 13, further comprising:

an information processing device, an authentication control device, and an authentication device which can communicate with each other via a network; wherein

the input means is provided in the information processing device,

the camera control means is provided in the authentication control device, and

the image acquisition means and the face authentication means are provided in the authentication device.

(Supplementary Note 15)

An authentication control method comprising:

a camera control step of photographing an image including the face of the user by starting a camera in response to the user's input operation to the input means of an information processing device equipped with an input means;

an image acquisition step of acquiring the image photographed by the camera;

authentication control step of causing an authentication device for performing face authentication to perform face authentication of the user included in the image acquired by the image acquisition means.

(Supplementary Note 16)

A non-transitory computer readable medium storing a program for causing an electronic device having at least one processor to execute:

a camera control processing of photographing an image including the face of the user by starting a camera in response to the user's input operation to the input means of an information processing device equipped with an input means;

an image acquisition processing of acquiring the image photographed by the camera;

authentication control processing of causing an authentication device for performing face authentication to perform face authentication of the user included in the image acquired by the image acquisition means.

### REFERENCE SIGNS LIST

1 AUTHENTICATION SYSTEM

10 AUTHENTICATION DEVICE

11 STORAGE UNIT

11a PROGRAM

11b FACE INFORMATION DB

12 CONTROL UNIT

12a IMAGE ACQUISITION UNIT

12b FACE DETECTION UNIT

12c FEATURE POINT EXTRACTION UNIT

12d REGISTRATION UNIT

12e AUTHENTICATION UNIT

13 MEMORY

14 COMMUNICATION UNIT

20 AUTHENTICATION CONTROL DEVICE

21 MEMORY

21a PROGRAM

21b PERSONAL AUTHENTICATION INFORMATION

22 CONTROL UNIT

22a DISPLAY CONTROL UNIT

22b CAMERA CONTROL UNIT (CAMARA CONTROL MEANS)

22c IMAGE ACQUISITION UNIT (IMAGE ACQUISITION MEANS)

22d AUTHENTICATION CONTROL UNIT (AUTHENTICATION CONTROL MEANS)

22e AUTHENTICATION INFORMATION ACQUISITION UNIT (FACE AUTHENTICATION RESULT ACQUISITION UNIT)

22g VERIFICATION UNIT

22h PROCESSING CONTROL UNIT

23 MEMORY

24 COMMUNICATION UNIT

30 SETTLEMENT TERMINAL (INFORMATION PROCESSING DEVICE)

31 CAMERA

32 DISPLAY UNIT

33 TOUCH PANEL (INPUT MEANS)

34 MEMORY

34a PROGRAM

35 CONTROL UNIT

35a DISPLAY CONTROL UNIT

35b INPUT STATE DETECTION UNIT

35c PHOTOGRAPHING CONTROL UNIT

35d SETTLEMENT PROCESSING UNIT

36 MEMORY

37 COMMUNICATIONS UNIT

B SETTLEMENT BUTTON

G1 PIN INPUT ACCEPTANCE SCREEN

G2 SETTLEMENT EXECUTION INQUIRY SCREEN

NW NETWORK

What is claimed is:

1. An authentication control device comprising:
at least one memory storing instructions, and
at least one processor configured to execute the instructions to;
photograph an image including the face of the user by starting a camera in response to the user's input operation to the input unit of an information processing device equipped with an input unit;
acquire the image photographed by the camera;
cause an authentication device for performing face authentication to perform face authentication of the user included in the image acquired.

2. The authentication control device according to claim 1, wherein
the input unit is an input unit that causes the user to input the authentication information assigned to the user,
the at least one processor is further configured to execute the instructions to acquire the authentication information entered via the input unit;
verify the authentication information acquired with the registered authentication information; and
when face authentication by the authentication device is successful and the verification result matches, cause an execution of the predetermined processing.

3. The authentication control device according to claim 2, wherein
the predetermined processing is a settlement processing and a processing for opening a gate or a door through which the user passes.

4. The authentication control device according to claim 2, wherein
the at least one processor is further configured to execute the instructions to start the camera to photograph the image after the start of the input of the authentication information and before the end of the input.

5. The authentication control device according to claim 2, wherein
the at least one processor is further configured to execute the instructions to
detect the input state of the authentication information; wherein
control the camera to photograph the image, when the start of input of the authentication information is detected.

6. The authentication control device according to claim 1, wherein
the at least one processor is further configured to execute the instructions to stop starting of said camera when photographing is completed.

7. The authentication control device according to claim 1, wherein
the input unit is an input unit configure to input authentication information by a finger of the user.

8. The authentication control device according to claim 7, wherein
the input unit is a touch panel arranged so as to cover the display surface of the display unit.

9. The authentication control device according to claim 8, wherein
display an authentication information input screen including images representing respective elements constituting the authentication information on a display surface of the display unit;
the images will be traced by the fingers of the user via the touch panel.

10. The authentication control device according to claim 7, wherein
the camera is arranged to photograph the face of the user who is inputting the authentication information via the input unit from the front.

11. An information processing device comprising:
an input unit;
at least one memory storing instructions, and
at least one processor configured to execute the instructions to;
photograph an image including the face of the user by starting a camera in response to the user's input operation to the input unit;
acquire the image photographed by the camera;
transmit the image acquired.

12. The information processing device according to claim 11, wherein
the at least one processor is further configured to execute the instructions to start the camera to photograph the image after the start of the input of the authentication information and before the end of the input.

13. An authentication system comprising:
an input unit;
at least one memory storing instructions, and
at least one processor configured to execute the instructions to;
photograph an image including the face of the user by starting a camera in response to the user's input operation to the input unit;
acquire the image photographed by the camera;
execute face authentication of the user included in the image acquired.

14. An authentication system according to claim 13, further comprising:
an information processing device, an authentication control device, and an authentication device which can communicate with each other via a network; wherein
input unit is provided in the information processing device,
the authentication control device photographs the image, and
the authentication device acquires the image and executes face authentication of the user.

15. An authentication control method comprising:
a camera control step of photographing an image including the face of the user by starting a camera in response to the user's input operation to the input unit of an information processing device equipped with an input unit;
an image acquisition step of acquiring the image photographed by the camera;
authentication control step of causing an authentication device for performing face authentication to perform face authentication of the user included in the image acquired.

16. A non-transitory computer readable medium storing a program for causing an electronic device having at least one processor to execute:
a camera control processing of photographing an image including the face of the user by starting a camera in response to the user's input operation to the input unit of an information processing device equipped with an input unit;
an image acquisition processing of acquiring the image photographed by the camera;
authentication control processing of causing an authentication device for performing face authentication to perform face authentication of the user included in the image acquired.
